(19) United States
(12) Patent Application Publication
(10) Pub. No.: US 2018/0052786 A1
(43) Pub. Date: Feb. 22, 2018

(54) IMPROVEMENT IN SENDING OF MULTIMEDIA STREAMS

(71) Applicant: Damien Plisson, Paris (FR)

(72) Inventor: Damien Plisson, Paris (FR)

(21) Appl. No.: 15/558,079

(22) PCT Filed: Mar. 24, 2016
(86) PCT No.: PCT/FR2016/050653

§ 371 Date: Sep. 13, 2017

(30) Foreign Application Priority Data
Mar. 27, 2015 (FR) 15 52617

(51) Int. Cl. G06F 13/16

(52) U.S. Cl. CPC G06F 13/1673; G06F 13/1689

(57) ABSTRACT

A method of sending multimedia streams to a multimedia peripheral of a computer, including a processor able to operate in user mode and in supervisor mode, a storage medium readable by the processor and storing a multimedia module, the method of sending comprising an implementation, by the multimedia module executed by the processor in supervisor mode, of an allocation, of a reception and of a sending.

The invention relates to improving the sending of multimedia streams, in particular audio streams. The increasing power of microcomputers, laptop computers, and tablets has enabled the development of real-time processing of audio recordings in which the main purpose is to correct errors due to playback and recording on CD and SACD media and to improve the purity of sound by eliminating noise due to digitization and interference introduced by the various components of the recording and reproduction chain.

Companies that have created hardware and software to do this have succeeded in obtaining a qualitative leap in the clarity and purity of the reconstructed sound.

The additional improvements which remain to be made to the best hardware and software are relatively minor as long as there is no solution to the physical problem of noise generated by the components used when reading the audio signal. The level of noise is related to the mode of operation of these components, and therefore to that of the controlling software.

The most advanced solutions implemented to date for digital music playback software are applied in the application level of the operating system used in these systems.

In the known solutions, only the audio device driver runs in the most privileged mode (kernel mode, also called supervisor mode).

The quality of the sending of the multimedia stream is imperfect in existing solutions.

The invention improves the situation.

One aspect of the invention relates to a method for sending a multimedia stream to a multimedia device of a computer, the computer comprising a processor able to operate in user mode and in supervisor mode, the computer comprising a storage medium readable by the processor and storing a multimedia module, the method for sending comprising an implementation, by the multimedia module executed by the processor in supervisor mode, of
/a/ an allocation, in kernel space, of a buffer arranged to contain at least ten seconds of multimedia stream;
/b/ a reception of a multimedia stream, and its storage in the buffer;
/c/ a sending of a multimedia stream stored in the buffer, to the multimedia device.

This method is particularly advantageous in that it allows improving the quality of the sound and/or video contained in a multimedia stream sent by such a method. By implementing the execution of the multimedia module in supervisor mode, the method gives it a very high priority for real time management of the multimedia stream. In addition, by allocating a buffer for it of an unconventional size because very large (at least ten seconds) and placing the buffer in kernel space (accessible only in supervisor mode), the method ensures greater continuity in the sending of the multimedia stream, which is less likely to be interrupted (even for very short periods), thus also ensuring a higher quality when sending. In addition, the use of kernel space (compared to the use of user space) implies a reduced use of memory and processor resources, because it requires less memory copying and fewer processor context switches which are likely to generate electrical and electromagnetic interference during the sending of a multimedia stream.

Another aspect of the invention relates to a computer program comprising a series of instructions which, when executed by a processor, implement a method according to an aspect of the invention.

Another aspect of the invention relates to a computer-readable non-transitory storage medium comprising a computer program according to an aspect of the invention.

Another aspect of the invention relates to a system for sending a multimedia stream, comprising a computer and a multimedia device, the computer comprising a processor able to operate in user mode and in supervisor mode, the computer comprising a storage medium readable by the processor and storing a multimedia module, the multimedia module being arranged to be executed by the processor in supervisor mode, the system for sending comprising:
a circuit for allocating, in kernel space, a buffer arranged to contain at least ten seconds of multimedia stream;
a circuit for receiving a multimedia stream, arranged to receive said multimedia stream and store it in the buffer;
a circuit for sending a multimedia stream stored in the buffer, to the multimedia device.

This system is advantageous in that it is particularly suitable for implementing a method according to the invention, and thus improves the quality of the sound and/or video contained in a multimedia stream when sending said stream.

Other aspects, objects, and advantages of the invention will be apparent from the description of several of its embodiments.

The invention will also be better understood with the aid of drawings, in which:

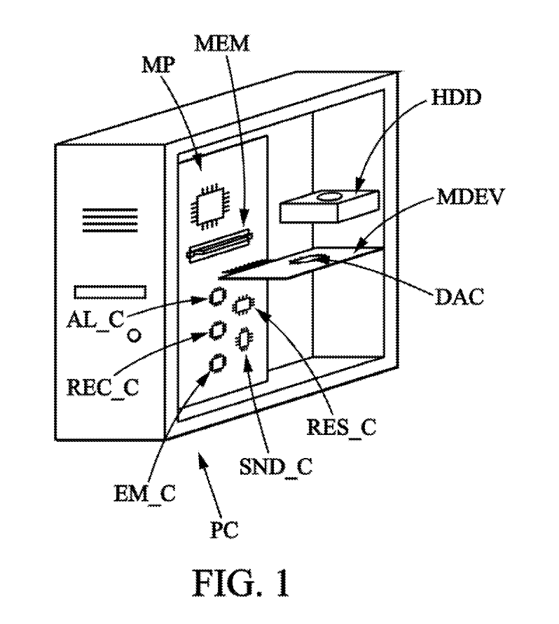

FIG. 1 illustrates a system for sending a multimedia stream according to one embodiment;

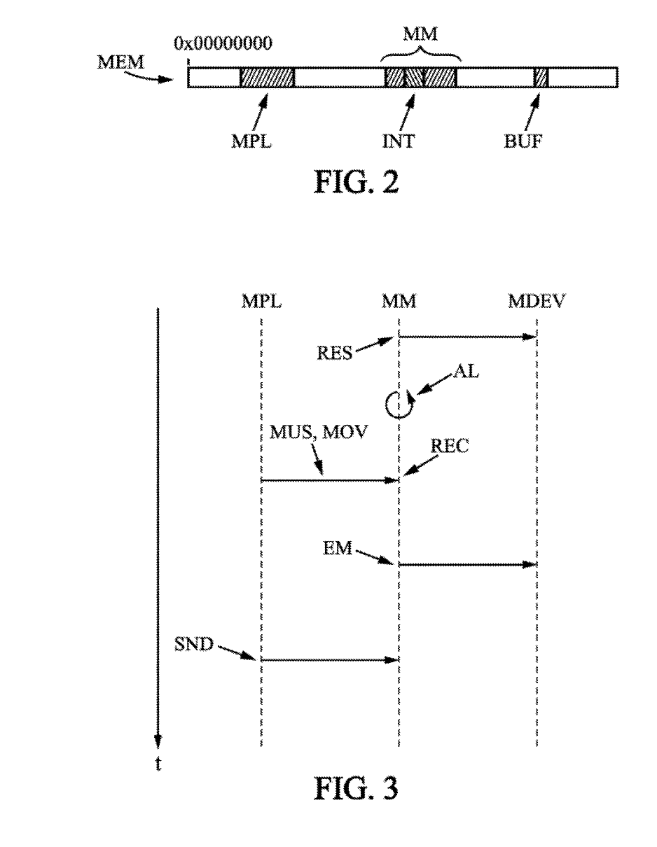

FIG. 2 schematically illustrates the contents of a memory MEM according to one embodiment;

FIG. 3 illustrates a method for sending a multimedia stream according to one embodiment;

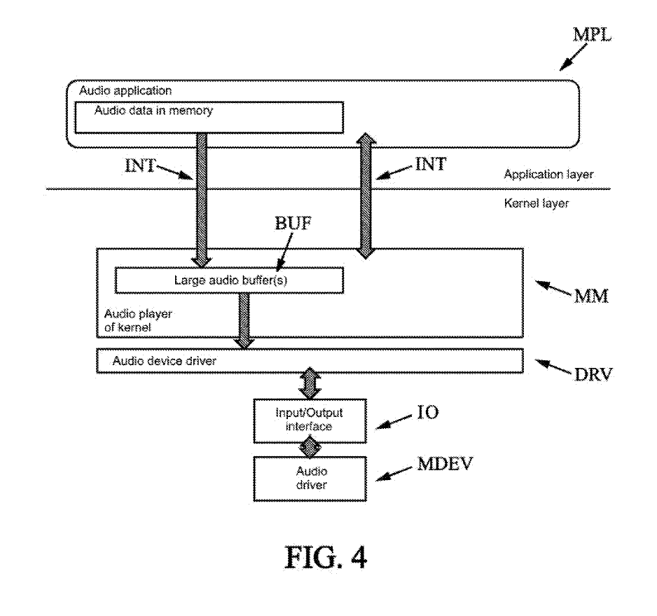

FIG. 4 illustrates the architecture of a system according to one embodiment;

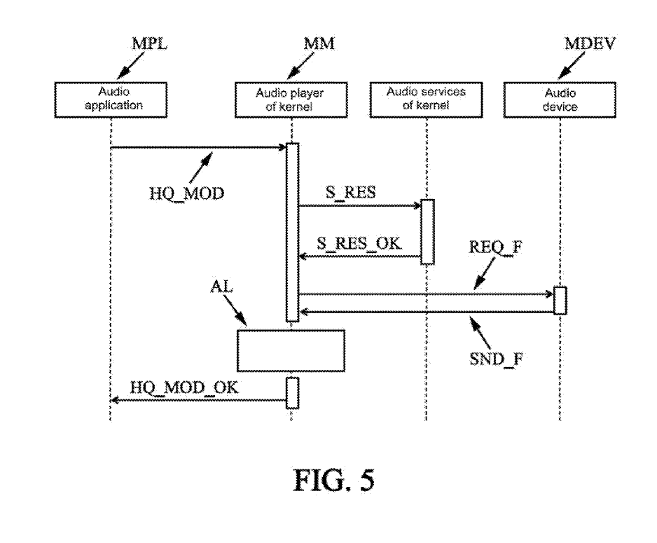

FIG. 5 illustrates a procedure for initializing a method according to one embodiment;

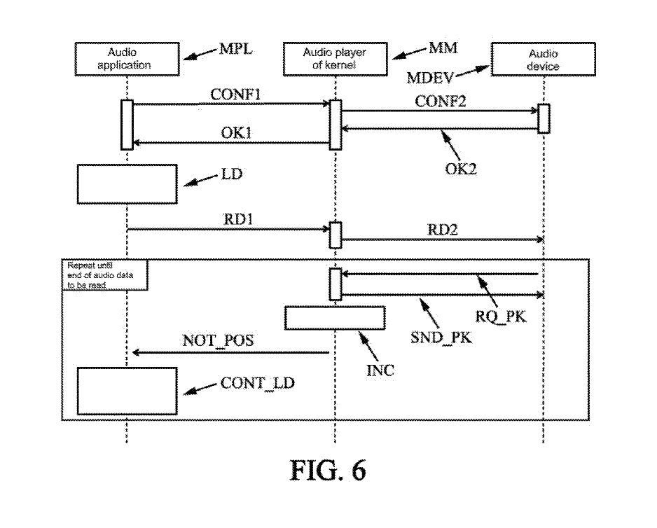

FIG. 6 illustrates an audio playback according to one embodiment;

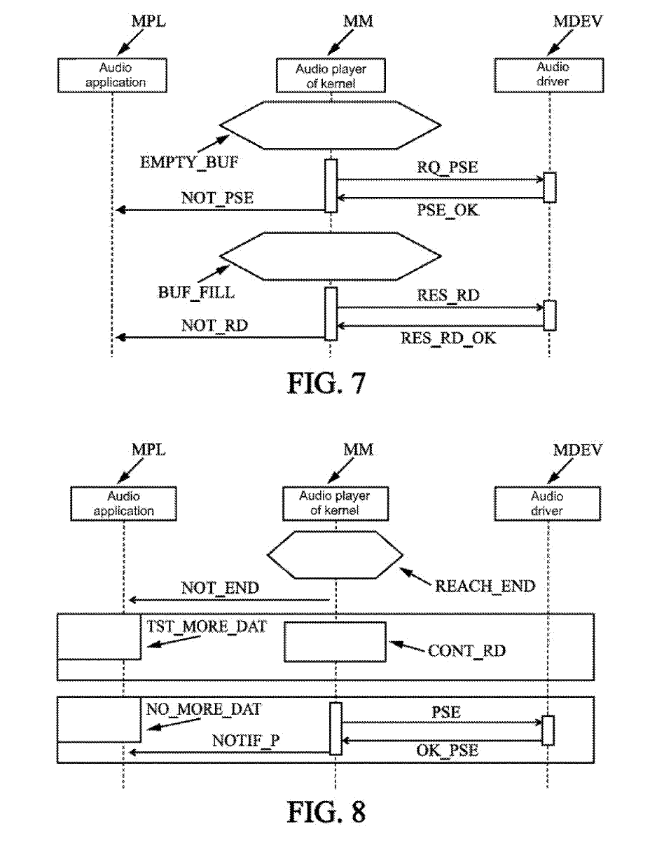

FIG. 7 illustrates an automatic pause according to one embodiment;

FIG. 8 illustrates a method for detecting and processing the end of the sending of a piece of music according to one embodiment;

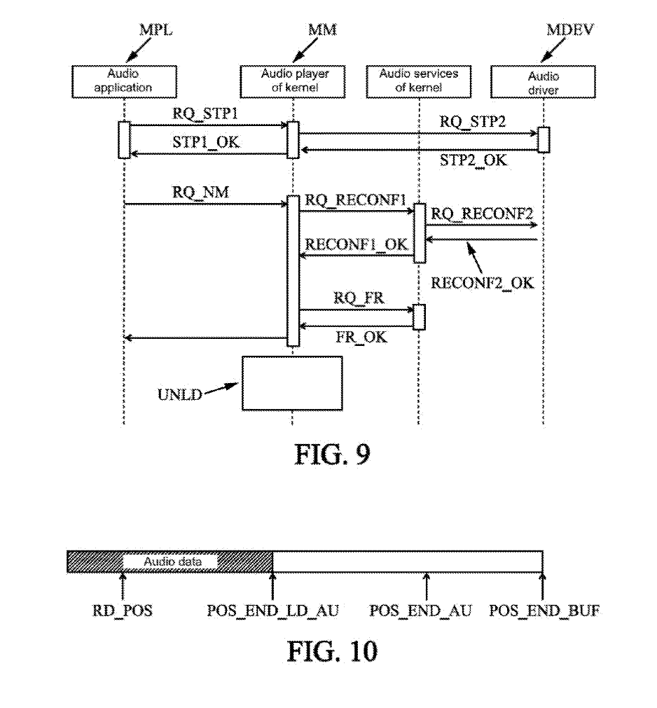

FIG. 9 illustrates a method for stopping the sending of a piece of music according to one embodiment;

FIG. 10 illustrates a buffer in kernel space, according to one embodiment.

In the figures described below, the embodiments often concern an audio stream, but these embodiments also apply to other types of streams.

FIG. 1 illustrates a computer PC comprising a hard drive HDD, a multimedia device MDEV, and a motherboard. Alternatively, the multimedia device MDEV may be integrated into the motherboard. The multimedia device MDEV comprises a digital-to-analog converter DAC, for example for converting digital data originating from a multimedia stream MUS (encoded music, which can be the audio portion of a video stream) into a voltage suitable for controlling a loudspeaker (in order to reproduce, by means of the loudspeaker, the music encoded in the multimedia stream MUS, possibly after amplification by an amplifier). The devices for attaching the hard drive HDD and the multimedia device are not represented.

The motherboard is equipped with a processor MP (whose cooling system is not shown) and at least one RAM memory module MEM (for example a DIMM stick of DDR3 SDRAM).

The motherboard is also equipped with five circuits AL_C, REC_C, EM_C, RES_C, and SND_C. These circuits are represented as separate discrete electronic components. However, in one possible implementation, the functions of these five circuits are fulfilled by one circuit providing these different functions. In one possible implementation, the five circuits are implemented by a circuit consisting of the combination of the processor MP and the memory MEM containing specific programs, in a manner described more specifically below.

The motherboard also comprises a connector for storage (for example SATA, SCSI, or IDE), not shown, for connecting the hard drive HDD, and a connector for expansion cards (for example PCI, PCI Express, or AGP), not shown, in particular for connecting the multimedia device MDEV.

A bus (not shown) connects the various components of the motherboard (Including the microprocessor MP, the memory MEM, the multimedia device MDEV, the hard drive HOD, and the different circuits AL_C, REC_C, EM_C, RES_C, and SND_C).

FIG. 2 schematically illustrates the contents of a memory MEM according to one possible embodiment. The memory represented is addressed in 32-bit mode (as illustrated by the initial address 0x00000000), but can of course be addressed in 64-bit or some other appropriate addressing. Starting from a first physical address, the memory MEM contains executable code for a multimedia player MPL implemented in software form. Starting from a second physical address, the memory MEM contains executable code corresponding to a multimedia module MM. This multimedia module MM contains an interface INT, which can take the form of an API, meaning a standardized set of classes, methods, or functions which serves as an interface through which the software provides services to other programs. Starting from a third physical address, the memory MEM contains executable code corresponding to a buffer BUF. As the kernel is normally loaded with user applications beforehand, the memory required for the multimedia module MM and its interface INT is normally allocated before the memory needed for the multimedia player MPL. It is therefore possible that the physical address of the memory block containing the multimedia module MM is lower than the physical address of the memory block containing the multimedia player MPL (the relative positions of the memory blocks in FIG. 2, which show a reverse configuration, are illustrative only). The three areas in memory storing the above information are each represented as continuous areas. However, in practice this is not necessarily so. Thus, although the buffer is usually allocated as one continuous block (meaning that any address corresponding to data in the buffer is immediately adjacent to at least one other address containing data in the buffer), this is often not the case for the multimedia module MM or the multimedia player MPL, which may each be loaded into a set of multiple non-contiguous blocks of memory (separated by unallocated areas of memory or areas allocated to other applications). Also, FIG. 2 shows information stored according to their physical addresses. The virtual addresses (which are usually assigned by an MMU integrated into the processor and which allow ignoring the physical addresses) can be different from the physical addresses (and usually are).

FIG. 3 illustrates a method for sending a multimedia stream according to one possible embodiment.

During an exclusive reservation step RES, a multimedia module MM establishes an exclusive reservation for a multimedia device MDEV. An arrow symbolically points from the multimedia module MM to the multimedia device MDEV. According to one possible implementation, the multimedia device thus receives a request, which it processes for example using an integrated microcontroller of the multimedia device. However, the exclusive reservation is not necessarily sent to the multimedia device. According to one possible implementation, the request is sent for example to a device driver of the multimedia device, which manages the exclusive reservation of the multimedia device and may not even inform the multimedia device of its exclusive reservation. After the entirety of a multimedia stream has been sent (for example an entire film), the multimedia module may automatically release the multimedia device (in order to end the exclusive reservation).

In an allocation step AL (which may follow or precede the exclusive reservation step RES), the multimedia module MM allocates a large buffer BUF in the kernel space.

In a step of receiving REC the multimedia stream, the multimedia module MM receives (as a block of data) a multimedia stream segment (for example a few seconds of music MUS or video MOV) from a multimedia player MPL. It saves this segment in the buffer BUF. Where appropriate, it receives such segments as long as the buffer is not full.

In a step EM of sending the multimedia stream, the multimedia module MM sends (as a block of data) a multimedia stream segment contained in the buffer BUF, to the multimedia device MDEV. Once the buffer has been filled, part of its contents having been sent in this manner, the multimedia module MM is arranged to again receive multimedia stream segments as long as the buffer is not full once again. The sent portions of the multimedia stream do not necessarily coincide exactly with the received portions of the multimedia stream. For example, it is possible to receive a multimedia stream in blocks of 3 kilobytes and to send them in blocks of 2 kilobytes. The size of the blocks received and sent is not necessarily constant, as well. Thus, although the stream received and the stream sent are essentially identical, their subdivision (into blocks of data for receiving and blocks of data for sending) is not necessarily so.

For the sake of convenience, multimedia stream portions will be referred to by the term “multimedia stream”. Indeed; a multimedia stream portion remains a multimedia stream.

During a sending step SND, the multimedia player (MPL) sends, via an interface (INT) of the multimedia module MM, a request to select any given read position in the buffer (BUF). Despite the large size of the buffer, it is thus possible to jump forward without needing to wait for the buffer to be read (otherwise one must wait for the entire stream contained in the buffer to be sent) or needing to load new data in the buffer.

FIG. 4 illustrates the architecture of a system according to one embodiment. An audio application MPL that is loaded in the application level (in user space) reads a large amount of data representing a piece of music, from an audio data source (DVD, remote server, local file, etc.). It then transfers this data in the form of small packets to a buffer BUF of an audio player MM (a specific type of multimedia module) which is loaded in the kernel (in kernel space). It performs this data transfer via an interface INT, which also acts to send commands to the audio player of the kernel MM and to receive notifications from it. The audio player of the kernel MM in turn transfers these data to a device driver DRV of an audio peripheral MDEV. The device driver DRV is either external to the audio player of the kernel MM or is directly integrated into the audio player of the kernel MM. The data are then transferred to an input/output interface 10, then to the audio peripheral MDEV.

FIG. 5 illustrates an initialization procedure of a method according to one embodiment.

An audio application MPL running in user space sends a request HQ_MOD to an audio player MM of the kernel (running in kernel space) to switch to audiophile playback mode (high quality mode). If necessary, the audio application MPL loads the audio player of the kernel MM into kernel space beforehand.

The audio player of the kernel MM sends an exclusive reservation request S_RES to an audio service of the kernel in order to reserve an audio peripheral MDEV. This request leads to a disconnection from the rest of the audio system in order to cancel out any other request sent to the audio peripheral MDEV and not coming from the audio player of the kernel. The audio service of the kernel responds to the audio player of the kernel MM by sending a notification S_RES_OK indicating that the exclusive reservation was successful.

The audio player of the kernel MM sends a request REQ_F to the audio peripheral MDEV asking it to communicate the different formats it supports (sampling rate at 44.1 kHz for CD quality, at 96 kHz, number of supported channels, etc.). The latter responds by sending the supported formats in a message SND_F.

The audio player of the kernel MM then allocates AL a buffer BUF used for the audio data. This buffer is a large buffer (at least ten seconds of audio data).

The audio player of the kernel MM then signals to the audio application MPL, by means of a message HQ_MOD_OK, that the change to audiophile mode has been successful.

FIG. 6 illustrates an audio playback method according to one embodiment.

In order to play a piece of music MUS, an audio application MPL begins by sending a configuration message CONF1 to an audio player of the kernel MM. The contents of this message can be determined during an initialization procedure as represented in FIG. 5. The configuration message CONF1 can thus specify for example that the piece of music that will be sent is sampled at 24 bits at a frequency of 96 kHz, and is stereophonic. Other formats may of course be employed. The audio player of the kernel MM in turn sends a configuration message CONF2 to an audio peripheral MDEV. This message CONF2 may take the elements received in the message CONF1, and where appropriate may be preprocessed. Once configured, the audio peripheral MDEV responds that it was successful by a message OK2 sent to the audio player of the kernel MM which in turn informs the audio application MPL by means of a message OK1.

The audio application MPL then loads (step LD) the audio data into the buffer BUF of the audio player of the kernel MM. Once sufficient data has been loaded (for example an amount of data corresponding to at least one second of music), the audio application MPL sends a message RD1 to the audio player of the kernel MM to ask it to begin reading the audio data (meaning sending the data to the audio peripheral MDEV for playback on loudspeakers). The audio player of the kernel MM starts the reading by sending a message RD2 to the audio peripheral MDEV.

The read process thus triggers a loop which in principle repeats until the end is reached of the audio data of the piece of music to be played (in other words, until the entire piece of music has been processed). This loop includes the sending, by the audio peripheral MDEV to the audio player of the kernel MM, of a request RQ_PK asking that an audio data packet be sent. The audio player responds by sending the requested packet using a message SND_PK, and increments (in a step INC) the read position in the kernel buffer BUF so that the next read in the kernel buffer corresponds to the beginning of the next packet. Sent packets are constructed from data taken from the buffer. According to one possible implementation, the packets contain other information (such as a header indicating for example a packet size, a cyclic redundancy code, etc.). Alternatively, no request RQ_PK is sent, and the audio peripheral MDEV comprises a digital-to-analog converter DAC operating synchronously. The audio player of the kernel MM is then arranged to send audio data without request, itself deciding the sending frequency on the basis of the parameters of the audio peripheral MDEV.

Periodically (for example every second), the audio player of the kernel MM notifies the audio application MPL of the read position using a message NOT_POS. Alternatively (or additionally, when such is useful), the audio application MPL itself can access this information, for example using the interface INT of the audio player of the kernel (without waiting to receive notification).

The audio application MPL, on the basis of the notifications NOT_POS that it has received and/or on stream information it has read directly (without using such notifications), fills (step CONT_LD step) the kernel buffer BUF (as long as the piece of music has not been completely played).

FIG. 7 illustrates an automatic pause when awaiting data, according to one embodiment.

The audio player of the kernel MM is arranged to detect that the read position of the audio player of the kernel MM in the kernel buffer BUF has reached a position corresponding to the end of the loaded audio data, but which is not the end of piece position nor the end of buffer position. It performs this detection for example by detecting an EMPTY_BUF event (event triggered when the incrementing INC of the read position illustrated in FIG. 6 reaches the end of audio data position in the buffer), or a software interrupt, or a continuous loop test performed by a separate thread (a thread is sometimes called a “task”).

The audio player of the kernel then sends the audio peripheral MDEV a pause request RQ_PSE (so the audio peripheral will stop requesting audio packets). The audio peripheral MDEV responds with a message PSE_OK that the pause was successful. The audio player of the kernel MM then notifies the audio application MPL, by a notification NOT_PSE, that the audio peripheral MDEV is paused due to lack of data. In an alternative implementation, instead of sending a pause request RQ_PSE to the audio peripheral MDEV, the audio player of the kernel MM sends “silence” packets (meaning packets containing constant samples representing a zero signal corresponding to silence) until the buffer BUF has sufficient data once again. This alternative has the advantage of enhanced interoperability with any type of audio peripheral (the audio peripheral not being aware of the pause as it is simulated).

During this time, the audio player of the kernel continues to check the contents of the kernel buffer by a mechanism similar to that which allows it to detect that there is no more data in the kernel buffer. As soon as a sufficient amount of data is detected, for example by means of an event BUF_FILL, the player of the kernel sends a message RES_RD to the audio peripheral MDEV so that the latter resumes reading. The audio peripheral MDEV responds with a message RES_RD_OK that it has resumed reading, the audio player of the kernel MM notifying the audio application MPL by means of a notification NOT_RD.

FIG. 8 illustrates a method for detecting and processing the end of the sending of a piece of music according to one embodiment.

An audio player of the kernel MM is arranged to detect that the read position of the audio player of the kernel MM in a kernel buffer BUF has reached a position corresponding to the end of the buffer, or the end of a piece being played. It performs this detection for example by detecting an event REACH_END, by a software interrupt, or by a continuous loop test performed by a separate thread.

The audio player of the kernel then sends to an audio application MPL a notification NOT END of the end of reading the kernel buffer or of the end of reading the piece.

The audio application MPL then checks (step TST_MORE_DAT) whether audio data are present after this position, or in a next buffer (when there are multiple buffers). If such is the case, it continues reading from the current or next buffer as appropriate (step CONT_RD). Otherwise (step NO_MORE_DAT), the audio player of the kernel sends the audio peripheral MDEV a pause request PSE (so that the audio peripheral stops requesting audio packets). The audio peripheral MDEV responds with a message OK_PSE to indicate that the pause was successful. The kernel MM then notifies the audio application MPL, by a notification NOTIF_P, that the audio peripheral MDEV is paused due to lack of data. In an alternative implementation, instead of sending a pause request PSE to the audio peripheral MDEV, the audio player of the kernel MM sends it silence packets in the manner indicated above.

This allows automatically switching from reading the end of one piece to reading the beginning of the next piece.

FIG. 9 illustrates a method for stopping the sending of a piece of music according to one embodiment.

An audio application MPL asks an audio player of the kernel MM to stop the playing of a piece of music by an audio peripheral MDEV, by means of a request RQ_STP1. The audio player of the kernel MM asks the audio peripheral MDEV to stop playing the piece of music, by means of a request RQ_STP2.

The audio peripheral MDEV acknowledges to the audio player of the kernel MM that it has stopped playing, by means of a message STP2_OK. The audio player of the kernel MM notifies the audio player MPL that it has stopped playing, by means of a message STP1_OK.

The audio application MPL then asks the audio player MM to return to normal mode (non-audiophile), by means of a message RQ_NM.

The audio player of the kernel MM asks an audio service of the kernel, by means of a request RQ_RECONF1, for a reconfiguration of the audio peripheral MDEV. The audio service of the kernel asks the audio peripheral MDEV, by means of a request RQ_RECONF2, for the requested reconfiguration. The audio peripheral MDEV responds to the audio service of the kernel, by means of a notification RECONF2_OK, that it is reconfigured. The audio service of the kernel notifies the audio player of the kernel MM, by means of a notification RECONF1_OK, that the audio peripheral MDEV is reconfigured (and ready to be used again).

The audio player of the kernel MM then asks the audio service of the kernel, by means of a request RQ_FR, to end the exclusive reservation of the audio peripheral MDEV. The audio service of the kernel responds, by means of a notification FR_OK, that it has indeed ended this exclusive reservation. The audio player of the kernel MM so notifies the audio application MPL.

The audio player of the kernel MM can then be unloaded from the kernel, and before that it can release the buffer in kernel mode (step UNLD). Control of the audio peripheral MDEV can then be returned to the operating system.

FIG. 10 illustrates a buffer in kernel space according to one embodiment. The illustrated buffer comprises audio data currently being read. The current read position is identified by a pointer RD_POS. The end of the audio data loaded in the buffer is identified by a pointer POS_END_LD_AU. The end position of the piece (assuming it is located in the buffer) is identified by a pointer POS_END_AU. The buffer end position is identified by a pointer POS_END_BUF.

A first embodiment relates to a method for sending a multimedia stream (such as a music stream MUS, or a video stream MOV) via a multimedia device MDEV of a computer PC.

In one possible implementation, the multimedia device, which is a hardware device (such as a sound card, graphics card, or a combination of both), is an integral part of the computer. In an alternative implementation, the multimedia device is external to the computer and is simply connected to it (by a wired or wireless connection).

The computer is for example a personal computer (laptop or desktop), but it may also be for example a mobile phone, tablet, MP3 player, smart watch, server, or a network drive. According to one possible implementation, such a network drive constitutes all or part of an integrated housing containing both a computer part (capable of reading a multimedia stream from internal storage and/or from a computer network) and a hifi portion able to reproduce a multimedia stream in a manner discernible to the human ear.

The computer comprises at least one processor MP capable of operating in user mode and in supervisor mode (it may be a multi-core or single-core processor). In user mode, the processor fairly strictly verifies (under the control of the operating system) the access to resources (memory, peripherals, etc.), which prevents a particular software (executed in user mode) from monopolizing resources, causing a computer crash, or obtaining access to confidential information it is not supposed to be able to access. User mode is therefore the default mode used by software. However, the fact that user mode is subject to increased controls means that user mode is slower and less responsive. When memory is allocated by software running in user mode, it is allocated in the user space (space from which the memory of other programs and of the operating system is not accessible). When memory is allocated in supervisor mode, it is allocated in the kernel space, a space where all resources are visible. In kernel space, it is possible to access the portions of physical memory used by all software executed by the computer, and even to make changes (delete information, replace it, etc.), which can be very dangerous. In supervisor mode (also called kernel mode), the processor thus has almost unlimited access to computer resources, particularly memory. Kernel mode is therefore normally reserved for the operating system kernel, which manages low-level functions (device drivers, hardware access, etc.).

According to the first embodiment, the computer comprises a storage medium (such as a magnetic hard drive HDD, or a solid state drive SSD composed of memory such as flash memory, or any other type of storage medium) readable by the processor and storing a multimedia module MM. The multimedia module MM is for example the result of compiling a program written in a language ensuring sufficiently high performance (in contrast to certain interpreted languages, for example), such as C or C++. The multimedia module may even be the result of assembling software written directly in an assembly language, which can further optimize performance optimization. The multimedia module may also be a combination, in the sense that it can be the result of compiling a program written partly in a language such as C language, with some parts (critical from a performance point of view) written directly in an assembly language.

The multimedia module MM is designed to be executed by the processor MP in supervisor mode. This multimedia module is for example integrated into the kernel of the operating system installed on the computer, which may be a conventional operating system such as Microsoft Windows, Linux, OS X, Android, iOS, Windows Phone, BlackBerry, Symbian, etc. This multimedia module may for example be integrated into a device driver, in particular a device driver managing the multimedia device MDEV. This multimedia module may alternatively be installed at the same level as such a device driver (but not integrated therein). The multimedia module could also be integrated in a kernel extension that is dynamically loaded (on demand), or integrated directly within a monolithic kernel (it is thus possible to compile a kernel specifically for this use). Execution of the multimedia module in supervisor mode gives improved performance. In particular, it can enjoy priority over other modules running in parallel but in user mode. Execution in supervisor mode improves the response time to requests of the multimedia device (which may include requests to receive the next part of a multimedia stream it is currently playing). This improves the temporal precision of the signal carried by the multimedia stream, due to the priority of the multimedia module over all modules running in user mode, especially since the execution of the response process does not require calling routines in user mode in this case. As there is less activity required to send the multimedia stream in supervisor mode than what is required to send the multimedia stream in user mode, the noise (including electromagnetic) related to this activity is reduced.

The method for sending comprises an implementation, by the multimedia center, of an allocation, in kernel space, of one (or alternatively more) buffer(s) BUF arranged to contain (collectively, if there are several) at least ten seconds of multimedia stream. This buffer, in addition to being located in kernel space, thus has a much greater size than in the prior art, which makes it possible to ensure continuity in the sending of a multimedia stream.

The multimedia stream sent by the multimedia module to the multimedia device is in the form of data, which, before reaching the multimedia device, are likely to pass through several intermediate elements, including a device driver for the multimedia device and modules of a kernel of the computer operating system. New data are regularly stored in the buffer (able to be used by such kernel modules) to ensure continuity in the sending of the multimedia stream. Using an unconventional size (corresponding to at least ten seconds of multimedia stream) for this buffer enables data transfers (from a source of a multimedia stream, such as a multimedia player, to the multimedia module) of a much larger unit size, and thus greatly reduces the number of these transfers during the sending of the multimedia data to the multimedia device. This therefore greatly limits the generated additional activity for requesting and sending new data. This correspondingly reduces the electromagnetic interference generated by this additional activity.

The large size of the buffer is thus advantageous in that any disruption temporarily preventing the obtaining of data from a multimedia source can be compensated for, for a period of up to ten seconds or more.

According to one possible implementation, the ten second threshold is not strict and is understood to mean about ten seconds (for example, nine seconds may be enough). The duration of the buffers of the prior art is less than a second, and that of the buffer according to the invention is distinguished in that it is much longer (at least ten times as long).

Such a duration (at least ten seconds) seems sufficient to counter the effects, on the sending of a multimedia stream, of phenomena that could slow or greatly but temporarily disrupt the computer. Such phenomena may be related for example to a temporary lack of RAM. In such a case, it is common to use virtual memory to supplement the insufficient RAM. This virtual memory is based on a mass storage medium, much slower than RAM but of much greater capacity (typically a hard drive). If a portion of the multimedia stream to be sent is located in virtual memory, it is necessary to perform a memory swap operation to access it (the word “swap” meaning “exchange”), during which the data representing the multimedia stream portion stored in mass storage (for example on a hard drive) is loaded into RAM to replace data which have not been used for a long time. This memory swap operation, which can take a long time, may then cause (within the context of prior art solutions) an interruption in the sending of the multimedia stream. The use of a large buffer allows absorbing the memory swaps occasionally required without causing interruptions in the sending of the multimedia stream. Such phenomena can also be associated with the preparatory phase for automatic execution of background tasks. These may be due to particular to antivirus software, automatic data backup software (copying data newly saved on a hard drive of the computer to archival media), automatic hard drive maintenance (such as defragmentation), automatic search for updates to software installed on the computer, etc. These preparatory phases, even if they do not result in exceeding the capacity of the RAM, can lead to significant load on the processor. Operation in supervisor mode ensures higher processor availability than would be given to a module running in user mode, thus reducing the likelihood that the sending of the multimedia stream is affected. Moreover, even if the source of the multimedia stream (which where appropriate may make use of modules running in user mode) temporarily runs out of data due to such a preparatory phase, the large buffer compensates for such a lack of data for at least ten seconds.

The method for sending comprises an implementation, by the multimedia module, of a reception of a multimedia stream (for example from a remote server via a network, or from local storage such as a local hard drive or USB key), and its storage in the buffer. This multimedia stream is understood to be a multimedia stream portion corresponding to the buffer capacity. Thus, it is possible to maintain at least ten continuous seconds of multimedia stream, and as the buffer content is sent it is replaced by a subsequent portion of the multimedia stream, received analogously to the above reception, in a manner which keeps the buffer continually full to the extent possible.

The method for sending comprises an implementation, by the multimedia module, of a sending of a multimedia stream stored in the buffer BUF to the multimedia device. According to one possible implementation, this sending is carried out by sending small multimedia stream packets from the buffer BUF, the size of said packets being fixed by the multimedia device MDEV.

The multimedia stream may come from any source. It may come from a file stored in the computer, but it may also come from an external entity, for example a remote server (for example by means of a technique called “streaming”, sometimes called direct streaming or continuous playback).

In a second embodiment, a method for sending multimedia streams according to the first embodiment comprises an implementation, by the multimedia module MM, of an exclusive reservation RES of the multimedia device MDEV during the sending of the multimedia stream. No other software is thus able to interfere with the multimedia module MM by requesting concurrent access to the same multimedia device, when (as long as) the module is sending a stream to the multimedia device MDEV. For example, in the event that the multimedia device is a sound card, the reception of an email in electronic messaging software will not be able to trigger an untimely sound of a type that can not only be superimposed on (or interrupt) the sending of the multimedia stream, but could also disrupt such a sending (for example by generating noise related to the fact that the email software is attempting to access the same multimedia device and thus consumes resources of said multimedia device).

According to one possible implementation, the sending of the multimedia stream is continuous (except for user intervention requesting a pause for example), and the reservation remains exclusive until the end of the sending of the entire multimedia stream concerned (for example until the end of the full playback of an entire movie). The exclusive reservation can thus take place as a prerequisite to sending the entire multimedia stream (just before the beginning of a movie, for example) and remain in effect throughout the movie (which includes many receptions of multimedia stream portions and sendings of multimedia stream portions) without it being necessary to renew the exclusive reservation upon each reception of a new multimedia stream portion (the initial exclusive reservation persists).

According to one possible implementation, the exclusive reservation is done in the kernel of an operating system installed on the computer. This implementation comprises the replacement of a multimedia device driver or a kernel module controlling the multimedia device, with a new device driver (respectively a new kernel module) incorporating a function to refuse any connection with an application other than a defined multimedia source. The multimedia source is for example a multimedia player (in the form of an application module), only this application module being authorized by the new device driver (respectively driver). According to one possible implementation, the function takes as input parameters a multimedia source identifier and a bit where one value indicates an exclusive reservation is required and the other indicates that the exclusive reservation is longer required. According to one possible implementation, this function is made secure, for example by predefining the multimedia source or sources authorized to request an exclusive reservation and preventing any application other than those appearing in the list of authorized applications so predefined from performing an exclusive reservation. According to one possible implementation, there is only one authorized source, and the function does not take the source identifier as an input parameter. According to one possible implementation, all (or alternatively a portion) the functions of the device driver (respectively the kernel module) relating to the sending of the multimedia stream are changed so that these functions return an error code when an exclusive reservation has been made and when it identifies that the calling application module is not the one for which an exclusive reservation has been requested.

In another possible implementation, the exclusive reservation is done in the kernel of an operating system installed on the computer, as follows. An interface module that provides the interface between application modules and multimedia device drivers in the kernel is replaced with a new interface module integrating a function that allows refusing any connection with an application other than a given multimedia source, in a manner similar to that described in the preceding paragraph.

In another possible implementation, the exclusive reservation is done in the application layer of an operating system installed on the computer. The operating system provides a function to reserve exclusive access to the multimedia device. A multimedia source such as the multimedia player application calls this function of the operating system in order to establish an exclusive reservation.

In one possible implementation, the buffer is a circular buffer. The multimedia module maintains a pointer to the start of the multimedia stream (pointing to a multimedia stream portion contained in the circular buffer and about to be sent) and a pointer to the end of the multimedia stream (which can be identical to the pointer to the start of the multimedia stream if the circular buffer is full).

According to one possible notational convention, the value zero is assigned to the multimedia stream start pointer (regardless of the memory address corresponding to the beginning of the multimedia stream). For example, consider a circular buffer of 1,764,000 bytes (or 0x1AEAA0 bytes in hexadecimal notation), occupying an area of memory from address 0x03000000 to address 0x031AEA9F. Such a circular buffer can thus contain ten seconds of stereo audio data sampled at 16 bits per channel, at a frequency of 44.1 kHz. The beginning of the multimedia stream can thus be at any address between 0x03000000 and 0x031AEA9F inclusive (for example address 0x0305ABE6). Regardless of the multimedia stream start address @DFM, conventionally the value zero is assigned to the pointer to this start of the multimedia stream. The value associated with any other pointer to any address @Q located within the circular buffer is then conventionally defined as being equal to (@Q+SZBUF−@DFM) Mod SZBUF, SZBUF designating the size of the buffer (for example 1,764,000 in the above example). If the two multimedia stream start and end pointers have different values, the multimedia module attempts to receive more of the multimedia stream in the circular buffer until the two pointers have the same value. Although the memory address corresponding to the multimedia stream start pointer keeps changing as the buffer contents are progressively sent, and does so cyclically, in this notational convention one can permanently assign the zero reference value to it.

Of course, any other notational convention is possible.

In a third embodiment, the multimedia module MM of a method for sending a multimedia stream according to the first or second embodiment comprises an interface INT accessible from a multimedia player MPL executed by the processor MP in user mode, the method for sending comprising the sending SND to the multimedia module MM, by the multimedia player MPL via said interface INT, of a request to select any given read position in the buffer BUF. Thus, the multimedia module allows selecting a read position at an arbitrary position in the buffer, and not simply a predefined position such as the beginning of the buffer. This is particularly advantageous in view of the size of the buffer. Such a selection is of no interest for a buffer of a size consistent with prior art buffers, which are so short that selecting an arbitrary read position is not useful.

In another implementation, the buffer is a circular buffer according to the aforementioned implementation, the multimedia module therefore maintaining a multimedia stream start pointer and a multimedia stream end pointer. The request to select any given read position then concerns a third pointer whose value is between the value of the multimedia stream start pointer and the value of the multimedia stream end pointer (when the values of these pointers are defined according to the aforementioned notational convention). The sending of the multimedia stream from the circular buffer then occurs starting at the address defined by the third pointer (when the selection is made) and not from the multimedia stream start pointer. It is thus possible to move forward and back quickly without having to be able to receive more of the multimedia stream, as long as such rapid movements forward and back are confined to the contents of the circular buffer. Without this third pointer implementing the selection of any given read position, a fast forward followed by a rapid rewind implies a new download if there are no specific functions. Indeed, once the multimedia stream start pointer is moved to jump ahead, it is not possible to jump backward if is impossible to know what content is located before the multimedia stream start pointer (the previous content may have been overwritten by the reception of other content).

According to one possible implementation, the multimedia module is arranged to trigger a time delay upon the reception by the interface INT of a request to select a read position. According to one possible implementation, the length of the time delay is of the same order of magnitude as the maximum length of the multimedia streams that the buffer can contain. This time delay is interrupted by any new reception by the interface INT of another request to select a read position, a reception which again triggers such a time delay (as if there had been none previously). During the time delay, the multimedia module is prevented from overwriting a sliding area (the circular buffer) initially preceding the newly selected position (and thereafter moved along as the contents of the circular buffer are sent, so as to immediately precede the current sample which is sent). This sliding area initially contains data not sent due to the selection of a new read position. Then, during the time delay, the sliding area contains less and less unsent data and more and more data already sent (but which may need to be resent, depending on the instructions of the user of the method for sending). More specifically, the multimedia module seeks to fill the buffer to the maximum but without writing, during the time delay, in the buffer area so protected. In one implementation, the maximum size of this protected area is set to a duration corresponding to half the maximum duration of the multimedia stream contained in the total circular buffer, which is five seconds for example. Any other duration greater than a second but substantially less than the size of the circular buffer (for example 80% of the size of the circular buffer) can also be selected.

For example, consider a circular buffer of one minute, a time delay of two minutes, and a maximum size of the area to be preserved of thirty seconds. Let us assume that the buffer is full (normal case during the sending of a multimedia stream, unless there is a specific problem or the end of the entire multimedia stream has been reached). If the user of the method for sending wants to advance twenty seconds (for example if the current multimedia stream is boring or offensive and the user wants to skip it), the interface INT receives an instruction which results in advancing by twenty seconds. Instead of immediately overwriting (at least to the extent the throughput allows) the data corresponding to the twenty seconds not played, the time delay allows preserving these data. More specifically, at the very beginning of the fast forward, the multimedia module cannot preserve thirty seconds because it has only the last twenty seconds (due to the advance of twenty seconds) and therefore cannot write anything for ten seconds. Then for one minute and fifty seconds it preserves the last thirty seconds, and after this time it again fills the circular buffer completely without attempting to preserve the thirty seconds preceding the present moment in the multimedia stream. In the same configuration, if the user now wishes to advance forty seconds instead of twenty seconds, the multimedia module can immediately (to the extent permitted by the throughput) overwrite ten seconds of saved multimedia stream corresponding to a prior stream of more than thirty seconds preceding the present moment, and then maintains a minimum of thirty seconds for the next two minutes. One purpose of this function is for example to allow a user who has mistakenly jumped ahead, or who realizes he or she has jumped ahead more than was actually desired, to be able to rewind instantly even when there is a poor connection with the source of the multimedia stream, particularly in the presence of a very irregular connection which provides a satisfactory average throughput but has frequent interruptions.

In a fourth embodiment, the multimedia stream of a method for sending a multimedia stream according to one of the above embodiments is an audio stream MUS, and the multimedia device MDEV comprises a digital-to-analog converter DAC. This embodiment enables the sending of high quality (hifi) audio.

According to a fifth embodiment, a computer program comprises a series of instructions which, when executed by a processor, implement a method according to one of the preceding embodiments. This computer program may be written in the C language, the C++ language, or an assembly language.

In a sixth embodiment, a computer-readable non-transitory storage medium (for example a hard drive HDD, or nonvolatile memory such as flash memory or EEPROM) comprises a computer program according to the fifth embodiment.

According to a seventh embodiment, a system for sending a multimedia stream comprises a computer PC and a multimedia device MDEV, the computer PC comprising a processor MP able to operate in user mode and in supervisor mode, the computer comprising a storage medium HDD readable by the processor MP and storing a multimedia module MM, the multimedia module MM being arranged to be executed by the processor MP in supervisor mode.

The system for sending comprises an electronic circuit AL_C for allocating, in kernel space, a buffer BUF arranged to contain at least ten seconds of multimedia stream. According to one possible implementation, the allocation circuit comprises a processor and a memory, said memory containing a computer program arranged to implement the allocation in kernel space of the buffer BUF of at least ten seconds. The processor may be a central processing unit of the computer (which may be shared with other circuits) or a dedicated processor. The memory may be the main memory of the computer (which may be shared with other circuits) or dedicated memory. It may be non-transitory memory.

The system for sending comprises an electronic circuit REC_C for receiving a multimedia stream, arranged to receive said multimedia stream and store it in the buffer BUF. According to one possible implementation, the reception circuit comprises a processor and a memory, said memory containing a computer program arranged to receive said multimedia stream and store in said buffer BUF. The processor may be a central processing unit of the computer (which may be shared with other circuits) or a dedicated processor. The memory may be the main memory of the computer (which may be shared with other circuits) or a dedicated memory. It may be non-transitory memory.

The system for sending comprises an electronic circuit EM_C for sending a multimedia stream stored in the buffer BUF, to the multimedia device MDEV. According to one possible implementation, the sending circuit comprises a processor and a memory, said memory containing a computer program arranged to send the multimedia stream stored in the buffer BUF to the multimedia device MDEV. The processor may be a central processing unit of the computer (which may be shared with other circuits) or a dedicated processor. The memory may be the main memory of the computer (which may be shared with other circuits) or a dedicated memory. It may be a non-transitory memory.

According to an eighth embodiment, a system for sending multimedia streams according to the seventh embodiment comprises an electronic circuit RES_C for the exclusive reservation of the multimedia device during the sending of the multimedia stream. According to one possible implementation, the sending circuit comprises a processor and a memory, said memory containing a computer program arranged to exclusively reserve the multimedia device MDEV during the sending of the multimedia stream. The processor may be a central processing unit of the computer (which may be shared with other circuits) or a dedicated processor. The memory may be the main memory of the computer (which may be shared with other circuits) or a dedicated memory. It may be a non-transitory memory.

According to a ninth embodiment, the multimedia module MM of a system for sending a multimedia stream according to the seventh or eighth embodiment comprises an interface INT that is accessible from a multimedia player MPL executed by the processor MP in user mode, the system for sending comprising an electronic circuit SND_C enabling the multimedia player MPL to send to the multimedia module MM, via said interface INT, a request to select any given read position in the buffer BUF. According to one possible implementation, the sending circuit SND_C comprises a processor and a memory, said memory containing a computer program arranged to send a request by the multimedia player MPL to select any given read position in the buffer BUF to the multimedia module MM, via said interface INT. The processor may be a central processing unit of the computer (which may be shared with other circuits) or a dedicated processor. The memory may be the main memory of the computer (which may be shared with other circuits) or a dedicated memory. It may be a non-transitory memory.

A tenth embodiment relates to a system for sending a multimedia stream according to one of the seventh to ninth embodiments, wherein the multimedia stream is an audio stream MUS and wherein the multimedia device MDEV comprises a digital-to-analog converter DAC.

Of course, the present invention is not limited to the embodiment described above by way of example; it extends to other variants.

The disclosed features concerning the methods of the invention can be transposed to the corresponding systems of the invention, and vice versa. The embodiments described for pieces of music can be transposed to other types of multimedia streams, in particular video streams, audio-video streams, augmented reality video streams, or even streams of information controlling lighting devices (light projectors, lasers, etc.) or electromechanical devices (for example streams controlling robots or actuators connected to elements of a scene in order to implement special effects in a performance), in cases where very precise synchronization is required.

1. A method for sending a multimedia stream to a multimedia device of a computer, the computer comprising a processor able to operate in user mode and in supervisor mode, the computer comprising a storage medium readable by the processor and storing a multimedia module, the method for sending comprising, in the multimedia module executed by the processor in supervisor mode:
/a/ an allocation, in kernel space, of a buffer arranged to contain at least ten seconds of multimedia stream;
/b/ a reception of a multimedia stream, and its storage in the buffer;
/c/ a sending of a multimedia stream stored in the buffer, to the multimedia device.

2. The method for sending a multimedia stream according to claim 1, comprising an exclusive reservation, by the multimedia module, of the multimedia device during the sending of the multimedia stream.

3. The method for sending a multimedia stream according to claim 1, the multimedia module comprising an interface accessible from a multimedia player executed by the processor in user mode, the method for sending comprising a sending by the multimedia player to the multimedia module, via said interface, of a request to select any given read position in the buffer.

4. The method for sending a multimedia stream according to claim 1, wherein the multimedia stream comprises an audio stream, and wherein the multimedia device comprises a digital-to-analog converter.

5. A non-transitory computer program product comprising a series of instructions which, when executed by a processor, implement a method according to claim 1.

6. A non-transitory computer-readable storage medium comprising the computer program product according to claim 5.

7. A system for sending a multimedia stream, comprising:
a computer and
a multimedia device,
the computer comprising:
a processor able to operate in user mode and in supervisor mode, and
a storage medium readable by the processor and storing a multimedia module,
the multimedia module being arranged to be executed by the processor in supervisor mode,
the system for sending comprising:
a circuit for allocating, in kernel space, a buffer arranged to contain at least ten seconds of multimedia stream;
a circuit for receiving a multimedia stream, arranged to receive said multimedia stream and store it in the buffer;
a circuit for sending a multimedia stream stored in the buffer, to the multimedia device.

8. The system for sending a multimedia stream according to claim 7, comprising a circuit for the exclusive reservation of the multimedia device during the sending of the multimedia stream.

9. The system for sending a multimedia stream according to claim 7, the multimedia module comprising an interface accessible from a multimedia player executed by the processor in user mode, the system for sending comprising a circuit enabling the multimedia player to send to the multimedia module, via said interface, a request to select any given read position in the buffer.

10. The system for sending a multimedia stream according to claim 7, wherein the multimedia stream comprises an audio stream, and wherein the multimedia device comprises a digital-to-analog converter.
